(19) United States
(12) Patent Application Publication
(10) Pub. No.: US 2012/0173084 A1
(43) Pub. Date: Jul. 5, 2012

(54) METHOD FOR ROLLOVER DETECTION

(75) Inventors: Rudolf Ertlmeier, Geisenfeld (DE); Eric G. Mertz, Rochester, MI (US); Holger Faisst, Sinzing (DE)

(73) Assignee: Continental Automotive GmbH, Hannover (DE)

(21) Appl. No.: 13/383,894

(22) PCT Filed: Feb. 17, 2010
(86) PCT No.: PCT/DE2010/000182

§ 371 Date: Mar. 20, 2012

(30) Foreign Application Priority Data
Jul. 17, 2009 (DE) 10 2009 033 760.1

(51) Int. Cl. G06F 7/00; B60R 21/0132

(52) U.S. Cl. 701/45; 701/124

(57) ABSTRACT

A method is presented for rollover detection, taking into account the transverse vehicle acceleration and transverse vehicle velocity and at least one rotational state quantity about the driving direction axis, wherein a correction parameter for the transverse vehicle velocity and/or transverse vehicle acceleration is determined by determining a translational energy value from the transverse vehicle velocity and a rotational energy value from the rotational state quantity and the correction parameter from the energy values.

### CROSS REFERENCE TO RELATED APPLICATIONS

This application is the U.S. National Phase Application of PCT International Application No. PCT/DE2010/000182, filed Feb. 10, 2010, which claims priority to German Patent Application No. 10 2009 033 760.1, filed Jul. 17, 2009, the contents of such applications being incorporated by reference herein.

### FIELD OF THE INVENTION

The invention relates to a method for rollover detection according to the transverse vehicle acceleration and transverse vehicle velocity and at least one rotational state quantity about the longitudinal vehicle axis.

### BACKGROUND OF THE INVENTION

Vehicle rollovers occur more seldom in comparison with other types of accident, but the rate of fatal or severe injuries suffered by the passengers is higher. Passive passenger protection means which are to be triggered in a crash, such as airbags, roll bars, etc., may reduce such injuries if the rollover event can be predicted early in advance. On the other hand, the rollover algorithm is required to not activate these safety mechanisms in the case of lateral collision events, particularly not in the case of low-energy lateral collision events without any risk of rollover.

Traditional rollover detection methods are based on measuring the roll rate and the lateral and vertical acceleration. Certain rollover scenarios, such as the lateral impact against a curb or the lateral digging-in of the wheels in loose ground at the edge of the roadway, place high demands on early detection, and existing methods fail for these scenarios.

To improve rollover detection by means of vehicle velocity, in some cases the lateral velocity is mapped against the lateral acceleration (vy-ay map), for example.

Very low thresholds are required in such cases to detect rollovers early in advance, which leads to a high sensitivity also for non-triggering lateral crash events and the risk of erroneous triggering.

From DE 600 27 386 T2, which is incorporated by reference of corresponding EP 1101658 B1, which is incorporated by reference, a method is known for detecting a vehicle rollover, where an energy criterion, or an energy threshold value, is determined by way of a linear equation of the angle of rotation and a multiplier derived from the acceleration in the transverse direction and some predetermined constants.

The current rate of angular variation of the vehicle is subsequently compared with this energy criterion and the onset of a rollover is inferred therefrom. The energy criterion thus represents a dynamic threshold for rollover detection and is not intended for correcting the transverse vehicle acceleration or the transverse vehicle velocity.

Moreover, a safety mechanism in a vehicle during a rollover is known from DE 197 44 083 A1, which is incorporated by reference, where in one method step the rotational energy is used in addition to the trigger decision. Furthermore, also the transverse acceleration is factored in to take into account a rollover due to the vehicle colliding with a low obstacle and a tilting movement setting in during this collision. Also here, however, neither a Kanzler Tauscher energy value is determined, nor is a correction parameter derived from these two energy values for the transverse vehicle velocity or the transverse vehicle acceleration.

An arrangement for detecting vehicle rollovers is also known from DE 196 09 717 A1, which is incorporated by reference, where the rotational energy of the vehicle is derived from a plurality of yaw rate sensors. Yet again, neither is a translational energy value taken into account nor an adjustment of the transverse vehicle velocity or transverse vehicle acceleration made based on these energy values.

From DE 10 2006 060 309 A1, which is incorporated by reference, a method is known for detecting rollovers in vehicles, where the rollover is detected as a function of the kinetic power in the transverse vehicle direction, a potential energy, and a roll energy, wherein the kinetic power is taken into account in that a transition of the kinetic power to roll energy is determined. This means that a certain contribution of the translational energy, in this case in the form of the kinetic power, is added to the value of the roll energy to subsequently compare it with a trigger threshold. No adjustment is made, however, of the transverse vehicle acceleration or transverse vehicle velocity based on these energy values.

### SUMMARY OF THE INVENTION

An aim of the present invention is, therefore, to provide a method for rollover detection which enables a secure and faster distinction.

Advantageous further developments of the invention become apparent from the subclaims, combinations and further developments of individual features also being conceivable.

An essential idea of the invention is to determine a correction parameter for the transverse vehicle velocity and/or the transverse vehicle acceleration by determining a translational energy value from the transverse vehicle acceleration or the transverse vehicle velocity (which is often determined from the transverse vehicle acceleration by integration), respectively, and a rotational energy value from the rotational state quantity and subsequently determining the correction parameter from these energy values.

Hence, when mapping the lateral velocity against the lateral acceleration, the progression of the characteristic curve is changed by this correction parameter, wherein, in principle, a correction of the transverse vehicle velocity and/or transverse vehicle acceleration is conceivable and simply a matter of a specific calculation of the corresponding correction parameter. Analogously, this correction can also be applied when mapping the lateral acceleration against the lateral velocity.

It is thus proposed to improve the evaluation process by an energy term which describes how much lateral energy has been, is being, or can be converted to roll energy, or how much can be still absorbed by the vehicle structure or the collision opponent.

In a first approximation, this term measures how much of the lateral kinetic energy in a direction transverse to the driving direction has been converted to a rolling movement about the driving direction axis. These energy values are considered in relation to a critical energy value, which leads to a rollover at a particular critical roll angle. This energy value, on the other hand, describes the lateral energy absorption of the vehicle.

The lateral velocity and lateral acceleration enable a good prediction of the rollover risk at dynamic conditions, but may lead to misjudgments in situations of lateral collisions only or during very extreme driving maneuvers. Due to the energy absorption in the vehicle structure a lateral collision can lead to high lateral acceleration values rather than to a rollover. The correction parameter keeps the signal at a low value and can thus prevent an erroneous triggering during a lateral collision. The prediction accuracy is significantly increased by applying this term.

This energy balance approach can be further improved by the roll work, i.e. by the energy dissipated due to the displacement of the center of gravity in the tilt direction, and the translational work, i.e. the energy dissipated in particular due to friction by the lateral displacement of the vehicle in the direction transverse to the driving direction, as well as by the yaw quantities yaw work and yaw energy acting about the vertical vehicle axis, wherein these influencing quantities have a clearly decreasing influence, such that taking into account the rotational and translational energy alone will already lead to a distinct improvement of the prediction accuracy.

The translational or rotational energy value does not even need to be calculated exactly in the physical sense. A good approximation can be achieved already if the lateral energy value is estimated to be at least approximately proportional to the square of the transverse vehicle velocity and the rotational energy value is estimated to be at least approximately proportional to the square of the rotational velocity. The other factors provided for in the physical formulas are vehicle-constant quantities, such as mass and inertia and the rotational axes, and can therefore be assumed to be at least approximately constant. They can be taken into account in the calculation either as constants or be deducted while predetermining the critical energy value, such that the correction parameter in the end remains unchanged.

The quadratic dependence of the energy values can be basically replaced also by sectionally linearized characteristic curves or tabular values.

The translational and the rotational energy value are each evaluated relative to the critical energy value and the correction parameter is determined therefrom, wherein the critical energy value is predefined as a vehicle-specific value.

### BRIEF DESCRIPTION OF THE DRAWINGS

The invention is best understood from the following detailed description when read in connection with the accompanying drawings. Included in the drawings is the following figures:

FIG. 1 shows a block structure of the method

FIG. 2 shows an energy balance analysis of the rollover event

FIG. 3 shows the mapping of the lateral velocity against the lateral acceleration and the rollover limit, taking into account the correction parameter

FIG. 4 shows a comparison between the trigger diagram of a traditional algorithm and an algorithm of the invention

FIG. 5 shows the trigger time and the trigger behavior for different tests and algorithms

### DETAILED DESCRIPTION OF THE PREFERRED EMBODIMENTS

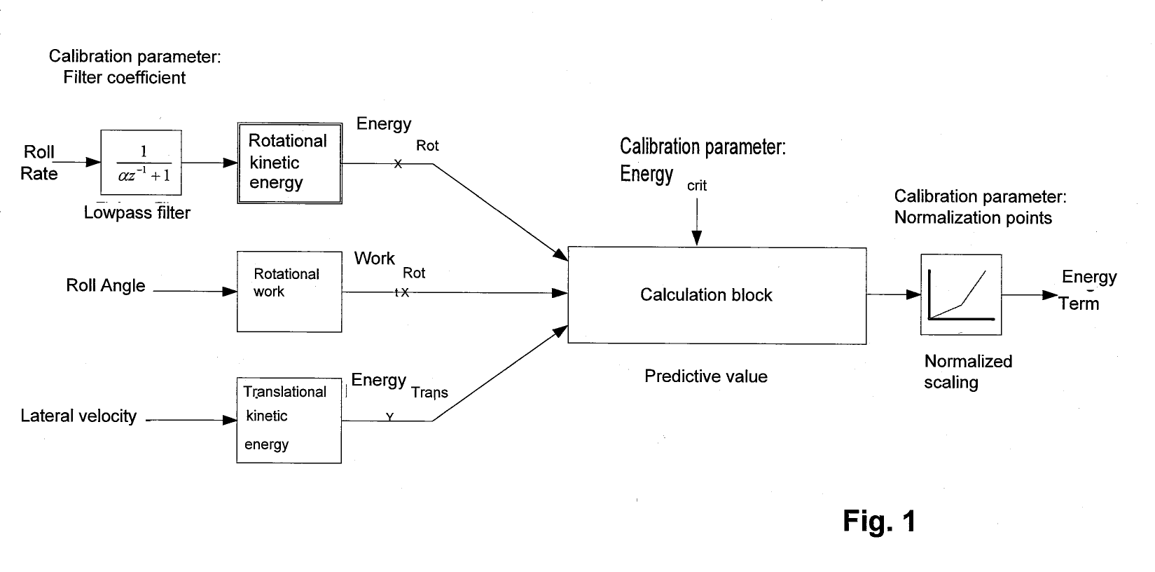

FIG. 1 shows a block structure of a preferred realization of the active rollover prediction optimized in terms of energy balance. The directions in the vehicle are basically described as an X-Y-Z coordinate system, wherein X corresponds to the driving direction, Y to the direction transverse to the driving direction and the roadway, and Z to the vertical axis, i.e. normal to the roadway.

In this exemplary embodiment, the following factors are used for calculating the correction parameter:
First of all the translational kinetic energy, preferably determined from the lateral velocity, which in turn is usually obtained by integration of the transverse acceleration determined by acceleration sensors. Alternatively, optical sensors, for example, can measure the transverse velocity directly.
Moreover, at least the rotational kinetic energy, which is obtained, for example, by the roll rate (which is preferably lowpass-filtered in this example).
As a particular further development, the roll work already performed is also taken into account, said roll work having been acquired from the absolute roll angle achieved, wherein the roll angle again is usually obtained from the yaw rate by integration.

In the calculation block, the correction parameter is then determined preferably according to the following formula:

$$K = ( \frac{{Energy}_{{Rot}_{x}} + {Work}_{{Rot}_{x}}}{{Energy}_{Crit}} ) ( 1 + \frac{{Energy}_{{Trans}_{y}}}{{Energy}_{Crit}} ) ,$$

wherein K is the correction parameter,
Energy_{Rot}_{ₓ} is the rotational energy value,
Energy_{Trans}_{_{y}} is the translational energy value,
Work_{Rot}_{ₓ} is the value of the rotational work performed, and
Energy_{Crit} is the critical energy value.

The predetermination of the critical energy value is done based on the individual vehicle type and depends heavily on the weight distribution and location of the center of gravity of the vehicle and its dynamic handling properties such as suspension and damping. This critical energy value is usually determined in the development stage by conducting rollover tests with the respective vehicles.

If required, the correction parameter can be scaled in addition based on normalization points.

Then the correction term is taken into account in the so-called v_{y}-a_{y} mapping, i.e. the mapping of the lateral acceleration against the lateral velocity, the velocity preferably being multiplied by the correction parameter.

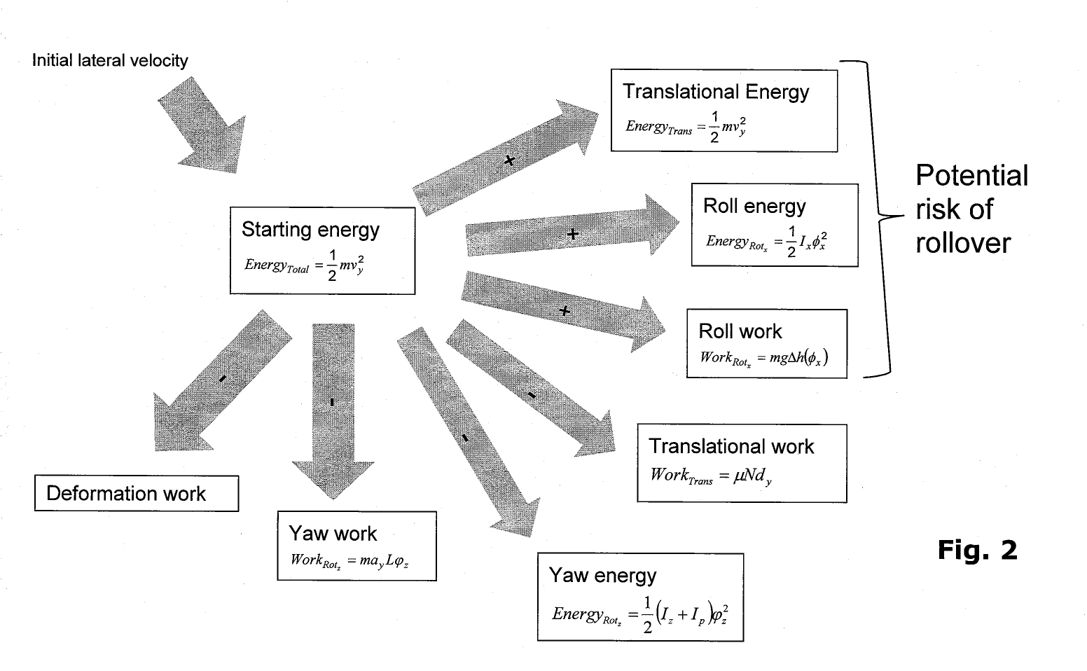

FIG. 2 outlines the energy balance of a rollover event, starting from an initial transverse movement vᵢ of the vehicle, which ultimately defines the starting energy which is then converted proportionally.

First of all, a portion of the translational energy will always be preserved, i.e. the vehicle will continue to perform a movement in the transverse direction (Y) even during rollover. Therefore, however, to predict a rollover the level of the current translational energy which has not been converted yet is important.

The roll energy describes the energy portion which has been already converted to a rolling movement, i.e. which results in an angular velocity about the driving direction axis. Both quantities, considered in relation to the critical energy value, form a measure of the rollover probability.

By taking account of the roll work already performed, this evaluation can be significantly improved even further. The lifting Δh of the center of gravity of the vehicle resulting from the roll rate, i.e. the tilting of the vehicle about the driving direction axis or an axis parallel thereto, is taken into account here.

The other energy portions, on the other hand, are usually rather uncritical with regard to the potential risk of rollover, i.e. they lead to an energy conversion to energy or work which is non-critical for rollover about the X-axis of the vehicle.

Then there is also the translational work, i.e. the displacement of the vehicle in the transverse direction by a distance d, taking into account the coefficient of friction, and the normal force, defined by the mass of the vehicle and the gravitational acceleration. This frictional work in itself does not increase the risk of rollover, but only the tilting of the vehicle itself which may be caused thereby, which, however, is taken into account already directly by the roll energy and, preferably, also by the roll work.

As the forces usually do not act symmetrically to the center of gravity of the vehicle and in particular the mass distribution and, therefore, inertia are not symmetrical, this results in yaw effects, i.e. rotations about the vertical axis Z of the vehicle, such that portions of the starting energy are also transformed into yaw work and yaw energy. While these quantities may be extremely critical for driving stability, e.g. may lead to skidding of the vehicle, they are irrelevant to the immediate detection of rollovers.

The largest energy portion in the event of a lateral impact is converted to plastic deformation of the vehicle. This portion, however, also does not increase the rollover risk.

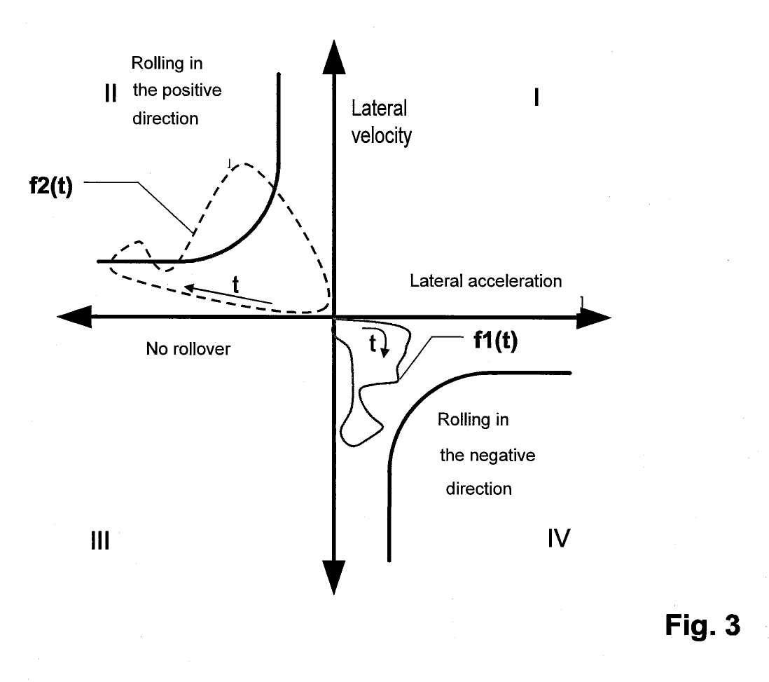

Overall, this results in a novel evaluation of the mapping of the lateral velocity against the lateral acceleration (vy-ay map) by introducing the correction parameter, here, for example, as a factor in connection with the lateral velocity. The novel progressions of the rollover limit can be clearly seen in FIG. 3. While f1(t) shows the progression of the value pairs of acceleration and energy-weighted velocity over time for a non-triggering event, f2(t) illustrates an exemplary progression of a rollover in the opposite direction, wherein, upon the rollover limit being first reached, the inevitability of the rollover is detected and corresponding safety mechanisms can be triggered.

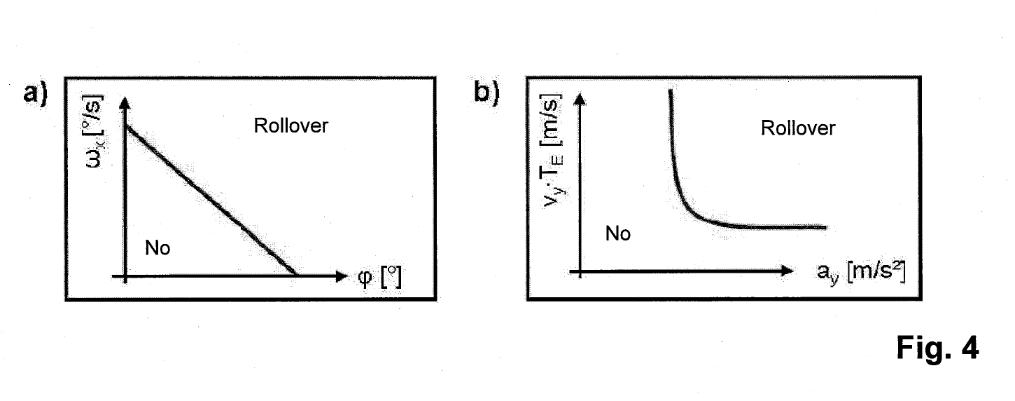

FIGS. 4a and 4b illustrate once again the different evaluation quantities and limit curves of the traditional rollover algorithm on the basis of the rotational angle and rotational velocity and the evaluation of the transverse velocity and transverse acceleration applied here taking into account an energy-based correction parameter.

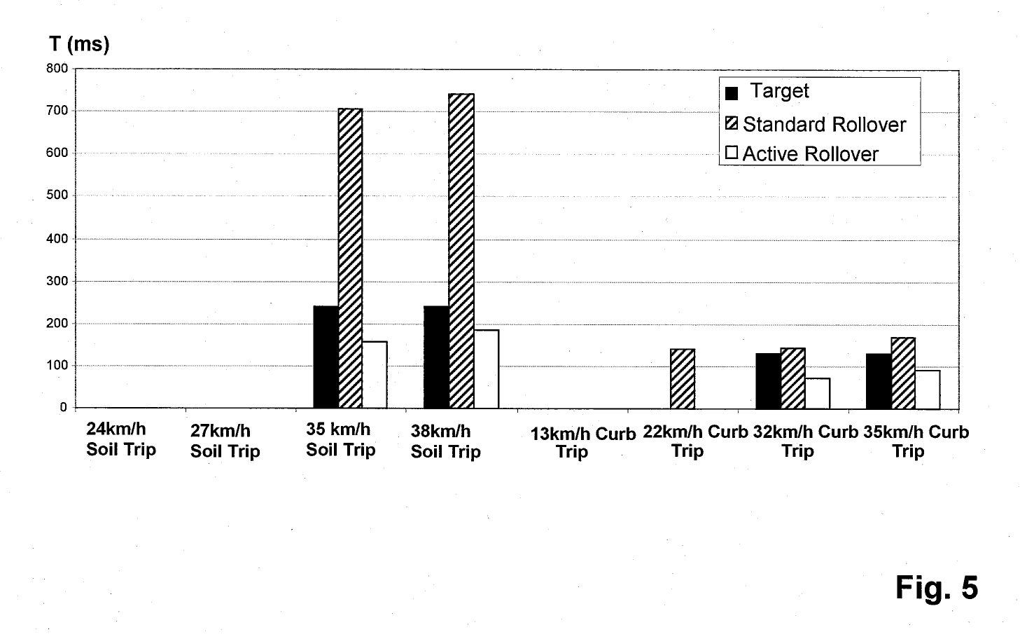

Now referring to FIG. 5, the trigger times, or the trigger behavior, are outlined for different tests for both the traditional algorithm based on rotational velocity and the algorithm according to aspects of the invention, here referred to as active rollover. For evaluation purposes the desired trigger behavior, or trigger time, is given as a black bar, i.e. if the black bar is missing, triggering is not desired.

The soil trip tests at low velocities are clearly detected as non-triggering events by both algorithms. The soil trip tests at a transverse velocity of approximately 30 km/h, however, usually result in a rollover, which might be detected later than desired with the traditional algorithm, whereas, with the energy-based algorithm, the high kinetic energy of the correction parameter evaluates the transverse velocity correspondingly higher, i.e. more rollover-critical, and thus results in an earlier triggering.

Also the curb trip tests illustrate the advantages of the energy-based algorithm, which, in particular, clearly recognizes even the test at 22 km/h as a non-triggering event, whereas the traditional algorithm leads to an erroneous triggering due to the rate of rotation being high for a short period of time when the impact occurs.

Soil trip and curb trip are defined rollover scenarios. While soil trips describe and simulate the lateral digging-in of the wheels in loose ground, curb trips describe laterally hitting the curb, which, depending on the transverse velocity present during these events, have an increasing risk of rollover. What can be clearly seen is that, particularly in the case of the soil trips, the traditional algorithm might by slower than the desired trigger times and the new algorithm corrected in terms of an energy value and being based on the transverse acceleration and transverse velocity provides advantages which can lead to a significant improvement of the passenger injury values.

It is a further advantage of this method that the traditional sensors for determining the transverse vehicle acceleration and the rate of rotation are sufficient for the controller, all quantities required for the algorithm being able to be derived from the signals of said sensors, and the implementation of the method thus requires merely enhanced software in the controller.

1.-9. (canceled)

10. A method for rollover detection, taking into account transverse vehicle acceleration and transverse vehicle velocity and at least one rotational state quantity about a longitudinal axis of the vehicle, comprising:
determining a correction parameter for at least one of the transverse vehicle velocity and the transverse vehicle acceleration by determining a translational energy value from the transverse vehicle velocity and a rotational energy value from the rotational state quantity and subsequently determining the correction parameter from these energy values.

11. The method according to claim 10, wherein the translational energy value is at least approximately proportional to the square of the transverse vehicle velocity.

12. The method according to claim 10, wherein the rotational energy value is at least approximately proportional to the square of the rotational velocity.

13. The method according to claim 10, wherein the rotational energy value in addition to the roll energy takes into account the roll work performed about the longitudinal vehicle axis.

14. The method according to claim 10, wherein a vehicle-specific predetermined critical energy value is taken into account in the correction parameter.

15. The method according to claim 14, wherein the translational and the rotational energy value are each evaluated relative to the critical energy value and the correction parameter is determined therefrom.

16. The method according to claim 15, wherein the correction parameter is determined according to:
$$K = ( \frac{{Energy}_{{Rot}_{x}}}{{Energy}_{Crit}} ) ( 1 + \frac{{Energy}_{{Trans}_{y}}}{{Energy}_{Crit}} ) ,$$
wherein K is the correction parameter,
Energy_{Rot}_{ₓ} is the rotational energy value,
Energy_{Trans}_{_{y}} is the translational energy value,
Energy_{Crit} is the critical energy value.

17. The method according to claim 16, wherein when determining the correction parameter, a value of the rotational work performed is additionally taken into account according to the following formula
$$K = ( \frac{{Energy}_{{Rot}_{x}} + {Work}_{{Rot}_{x}}}{{Energy}_{Crit}} ) ( 1 + \frac{{Energy}_{{Trans}_{y}}}{{Energy}_{Crit}} ) ,$$
wherein Work_{Rot}_{ₓ} is the value of the rotational work performed.

18. A controller for a passenger protection system, wherein said controller comprises sensors for determining the transverse vehicle acceleration and transverse vehicle velocity and at least one rotational state quantity about the driving direction axis as well as a method for rollover detection according to claim 10.
